(19) United States
(12) Patent Application Publication
(10) Pub. No.: US 2011/0281614 A1
(43) Pub. Date: Nov. 17, 2011

(54) RADIO BASE STATION AND COMMUNICATION CONTROL METHOD

(75) Inventor: Minako Kitahara, Kanagawa (JP)

(73) Assignee: KYOCERA CORPORATION, Kyoto (JP)

(21) Appl. No.: 13/146,375

(22) PCT Filed: Jan. 22, 2010
(86) PCT No.: PCT/JP2010/000355

§ 371 Date: Jul. 26, 2011

(30) Foreign Application Priority Data
Jan. 28, 2009 (JP) 2009-017136

(51) Int. Cl. H04W 52/04

(52) U.S. Cl. 455/522

(57) ABSTRACT

A radio base station 10 includes a reception quality calculation unit 31 for calculating a reception quality based on a signal received from a radio terminal, a difference information obtaining unit 33 for obtaining difference information between maximum transmit power and current transmit power, transmitted from the radio terminal, a minimum requirement calculation unit 41 for calculating a minimum requirement indicating a relation between the number of resource blocks and a modulation type, necessary to ensure a minimum level of quality required for communication with the radio terminal, wherein the resource block is a unit block with a predetermined frequency bandwidth, and control units (46, 47) for controlling at least one of the number of resource blocks, the modulation type and transmit power for uplink of the radio terminal based on the reception quality calculated by the reception quality calculation unit 31 and the difference information obtained by the difference information obtaining unit 33 such that the minimum requirement calculated by the minimum requirement calculation unit 41 is maximally met. Thereby, the radio terminal can be adaptively and efficiently controlled to reliably ensure a required communication quality without consuming power excessively.

### CROSS REFERENCE TO RELATED APPLICATION

This application claims priority to and the benefit of Japanese Patent Application No. 2009-17136 filed on Jan. 28, 2009, the entire contents of which are incorporated herein by reference.

### TECHNICAL FIELD

The present invention relates to radio base stations and communication control methods.

### BACKGROUND ART

For example, in LIE (Long Term Evolution), standardization of which has been promoted by 3GPP (3rd Generation Partnership Project), a base station allocates, to each of radio terminals, necessary numbers of resource blocks having predetermined frequency bandwidths as unit blocks, as a radio resource in an uplink. Then, a modulation type in the allocated radio resource and transmit power per resource block are controlled (for example, see Non-Patent Document 1).

### PRIOR ART DOCUMENT

### Non-Patent Document

Non-Patent Document 1: 3 GPP TR 25.814

### SUMMARY OF INVENTION

### Technical Problem

In the above radio system, however, controls for the number of allocated resource blocks, the modulation type and the transmit power are not related to one another but performed separately. Therefore, it is concerned that the number of resource blocks, the modulation type and the transmit power of each radio terminal are likely controlled to excessively satisfy QoS (Quality of Service) required for communication, resulting in excessive consumption of power by each radio terminal.

It is also concerned that some radio terminal may not be able to ensure a required QoS, as not being able to obtain necessary transmit power for the number of allocated resource blocks and the modulation type. Moreover, it is concerned that, if the modulation type is lowered to follow fading, the required QoS cannot be ensured with the number of allocated resource blocks.

Accordingly, it is an object of the present invention, in consideration of such problems, to provide radio base stations and communication control methods capable of adaptively and efficiently controlling radio terminals in order to reliably ensure the required communication quality without consuming power excessively.

### Solution to Problem

In order to achieve the above object, a radio base station according to a first aspect of the present invention includes:

a reception quality calculation unit for calculating a reception quality based on a signal received from a radio terminal;

a difference information obtaining unit for obtaining difference information between maximum transmit power and current transmit power, transmitted from the radio terminal;

a minimum requirement calculation unit for calculating a minimum requirement indicating a relation between a number of resource blocks and a modulation type, necessary to ensure a minimum level of quality required for communication with the radio terminal, wherein the resource block is a unit block with a predetermined frequency bandwidth; and

a control unit for controlling at least one of the number of resource blocks, the modulation type and transmit power for uplink of the radio terminal, such that the minimum requirement calculated by the minimum requirement calculation unit is maximally met, based on the reception quality calculated by the reception quality calculation unit and the difference information obtained by the difference information obtaining unit.

A second aspect of the present invention is the base station according to the first aspect, further including a propagation environment measurement unit for measuring a fading variation based on a signal received from the radio terminal, wherein

the control unit selects a corresponding minimum requirement among minimum requirements calculated by the minimum requirement calculation unit based on the fading variation measured by the propagation environment measurement unit, and controls the number of resource blocks and the modulation type of the radio terminal to the minimum requirement selected and controls the transmit power of the radio terminal such that the minimum requirement selected is maximally met.

Moreover, in order to achieve the above object, a communication control method according to a third aspect of the present invention includes the steps of:

calculating a reception quality based on a signal received from a radio terminal;

obtaining difference information between maximum transmit power and current transmit power, transmitted from the radio terminal;

calculating a minimum requirement indicating a relation between a number of resource blocks and the modulation type, necessary to ensure a minimum level of quality required for communication with the radio terminal, wherein the resource block is a unit block with a predetermined frequency bandwidth; and

controlling at least one of the number of resource blocks, the modulation type and transmit power for uplink of the radio terminal, such that the minimum requirement calculated at the step of calculating the minimum requirement is maximally met, based on the reception quality calculated at the step of calculating the reception quality and the difference information obtained at the step of obtaining the difference information.

### Effect of the Invention

According to the present invention, the radio base station controls at least one of the number of resource blocks, the modulation type and the transmit power for the uplink of a radio terminal based on the reception quality and the difference information of the transmit power such that the minimum requirement to satisfy a required communication quality is maximally met. Thereby, it is possible to adaptively and efficiently control the radio terminal to reliably ensure the required communication quality without consuming power excessively.

### BRIEF DESCRIPTION OF DRAWINGS

FIG. 1 is a diagram illustrating a schematic configuration of a radio base station according to an embodiment of the present invention;

FIG. 2 is a diagram illustrating a schematic configuration of a radio terminal for performing a radio communication with the radio base station shown in FIG. 1;

FIG. 3 is a flowchart illustrating operations by the radio terminal shown in FIG. 2;

FIG. 4 is a flowchart illustrating an outline of schematic operations by the radio base station shown in FIG. 1;

FIG. 5 is a diagram illustrating operations by the radio base station shown in FIG. 1; and

FIG. 6 is a diagram illustrating operations by the radio base station shown in FIG. 1.

### DESCRIPTION OF EMBODIMENT

An embodiment of the present invention will be described with reference to the accompanying drawings.

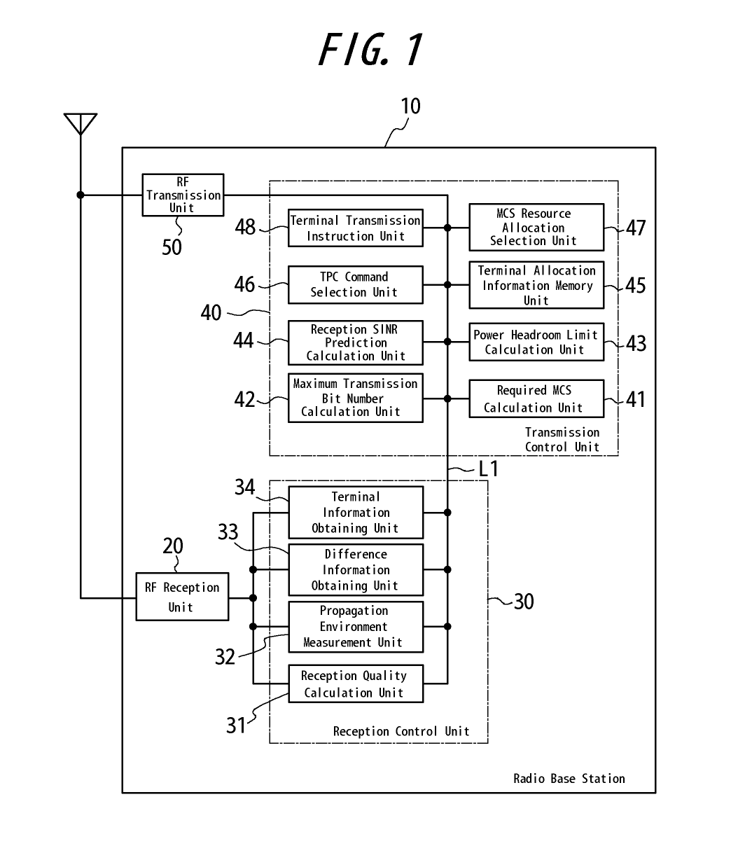

FIG. 1 is a diagram illustrating a schematic configuration of a radio base station according to an embodiment of the present invention. The radio base station 10 is in conformity with LTE, for example, and has an RF (Radio Frequency) reception unit 20, a reception control unit 30, a transmission control unit 40 and an RF transmission unit 50. The RF reception unit 20 receives a signal wirelessly transmitted from a radio terminal and provides the signal to the reception control unit 30.

The reception control unit 30 has a reception quality calculation unit 31, a propagation environment measurement unit 32, a difference information obtaining unit 33 and a terminal information obtaining unit 34. The reception quality calculation unit 31 calculates SINR (Signal to Interference and Noise Ratio) from a signal received by the RF reception unit 20 and outputs a result of calculation, as a reception quality, to a transmission control unit 40 via a bus line L1. The propagation environment measurement unit 32 measures a fading variation from the signal received by the RF reception unit 20 and outputs a result of measurement to the transmission control unit 40 via the bus line L1.

The difference information obtaining unit 33 obtains, from the signal received by the RF reception unit 20, difference information between maximum transmit power of the radio terminal and current transmit power, that is, power headroom information of the radio terminal in a unit block of a predetermined frequency bandwidth, and outputs the power headroom information obtained to the transmission control unit 40 via the bus line L1. In addition, the terminal information obtaining unit 34 obtains terminal information including the maximum transmit power and a maximum buffer size of the radio terminal from the signal received by the RF reception unit 20 and outputs the terminal information obtained to the transmission control unit 40 via the bus line L1.

The transmission control unit 40 has a required MCS (Modulation Class) calculation unit 41, a maximum transmission bit number calculation unit 42, a power headroom limit calculation unit 43, a reception SINR prediction calculation unit 44, a terminal allocation information memory unit 45, a TPC (Transmission Power Control) command selection unit 46, an MCS resource allocation selection unit 47, and a terminal transmission instruction unit 48, which are connected to the bus line L1. The required MCS calculation unit 41 calculates a required quality for communication with the radio terminal, that is, a minimum requirement indicating a relation between the number of resource blocks (RB) and the modulation type (MCS) in order to meet CNR (Carrier to Noise Ratio) required for ensuring a minimum level of QoS, and consists a minimum requirement calculation unit of the radio base station according to the present invention.

The maximum transmission bit number calculation unit 42 calculates the maximum number of transmission bits corresponding to the number of allocated RBs based on a maximum buffer size of the radio terminal included in the terminal information of the radio terminal obtained by the terminal information obtaining unit 34 of the reception control unit 30. The power headroom limit calculation unit 43 stores the power headroom information obtained by the difference information obtaining unit 33 of the reception control unit 30 in an updatable manner, and based on the power headroom information, calculates the number of allocated RBs and MCS that can be set for the radio terminal. The reception SINR prediction calculation unit 44 predicts SINR with transmit power selectable by a next TPC command to the radio terminal based on current reception quality information calculated by the reception quality calculation unit 31 of the reception control unit 30. The terminal allocation information memory unit 45 stores terminal allocation information such as the minimum requirement calculated by the required MCS calculation unit 41, the maximum number of transmission bits corresponding to the number of allocated RBs calculated by the maximum transmission bit number calculation unit 42 and the like, with respect to each terminal which communicates simultaneously.

The TPC command selection unit 46 and the MCS resource allocation selection unit 47 constitute a control unit of the radio base station according to the present invention. That is, the TPC command selection unit 46 selects the TPC command which specifies the transmit power for a next transmission of the radio terminal based on the maximum number of transmission bits corresponding to the number of allocated RBs calculated by the maximum transmission bit number calculation unit 42, the information calculated by the power headroom limit calculation unit 43, prediction information calculated by the reception SINR prediction calculation unit 44, the terminal allocation information stored in the terminal allocation information memory unit 45 and the like, such that the minimum requirement calculated by the required MCS calculation unit 41 is maximally met.

In addition, the MCS resource allocation selection unit 47 selects the minimum requirement (the number of RBs and MCS) necessary for the next transmission of the radio terminal, in consideration of the TPC command selected by the TPC command selection unit 46 and the fading variation measured by the propagation environment measurement unit 32 of the reception control unit 30. Then, the terminal transmission instruction unit 48 transmits the terminal transmission instruction information including the TPC command selected by the TPC command selection unit 46 and the minimum requirement selected by the MCS resource allocation selection unit 47 to the radio terminal via the RF transmission unit 50 in order to inform accordingly.

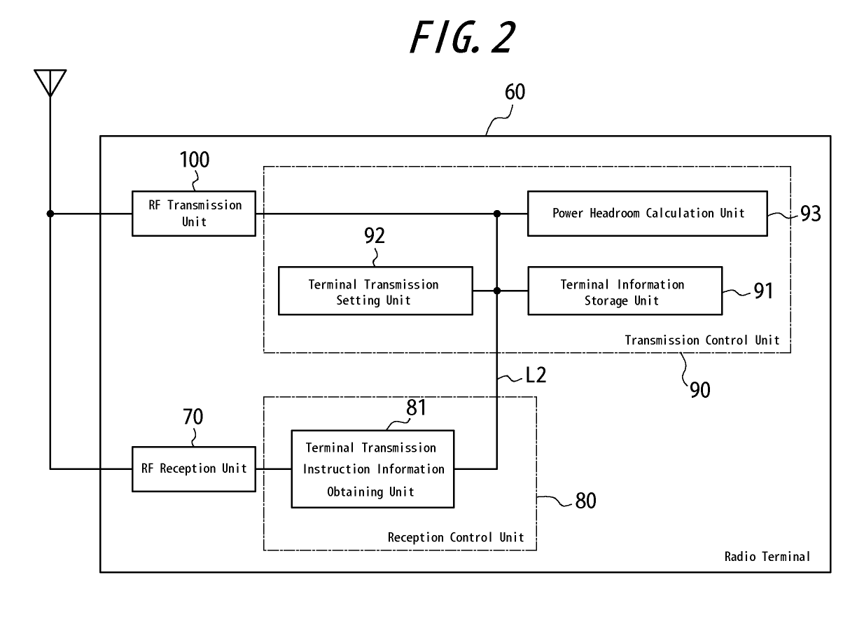

FIG. 2 is a diagram illustrating a schematic configuration of a radio terminal which performs radio communication with the radio base station 10 shown in FIG. 1. The radio terminal 60 has an RF reception unit 70, a reception control unit 80, a transmission control unit 90 and an RF transmission unit 100. The RF reception unit 70 receives a signal wirelessly transmitted from the radio base station 10 and provides the received signal to the reception control unit 80.

The reception control unit 80 has a terminal transmission instruction information obtaining unit 81. This terminal transmission instruction information obtaining unit 81 obtains terminal transmission instruction information from the signal received by the RF reception unit 20 and outputs the terminal transmission instruction information obtained to the transmission control unit 80 via a bus line L2.

The transmission control unit 90 has a terminal information storage unit 91, a terminal transmission setting unit 92, and a power headroom calculation unit 93, which are connected to the bus line L2. The terminal information storage unit 91 stores the terminal information including the maximum transmit power and the maximum buffer size of the radio terminal. The terminal transmission setting unit 92 sets the number of RBs, MCS and the transmit power in the uplink for transmission from the radio terminal to the radio base station 10 based on the terminal transmission instruction information obtained by the terminal transmission instruction information obtaining unit 81 of the reception control unit 80. The power headroom calculation unit 93 calculates power headroom, which is the difference information between the maximum transmit power of the radio terminal stored in the terminal information storage unit 91 and the current transmit power set by the terminal transmission setting unit 92.

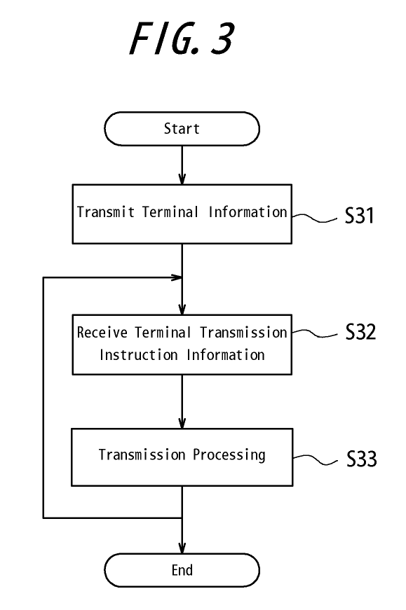

FIG. 3 is a flowchart illustrating an operation by the radio terminal 60 shown in FIG. 2. The radio terminal 60, in forming a radio link to the radio base station 10 shown in FIG. 1, wirelessly transmits the terminal information including the maximum transmit power and the maximum buffer size of the radio terminal 60 stored in the terminal information storage unit 91 of the transmission control unit 90 to the radio base station 10 via the RF transmission unit 100 (step S31). Then, upon reception of the terminal transmission instruction information from the radio base station 10 (step S32), the radio terminal 60 performs transmission processing by controlling the number of RBs, MCS and the transmit power for the uplink based on the terminal transmission instruction information (step S33) and starts necessary communications. Thereafter, processing at steps S32 and S33 is repeated to perform communication.

In the transmission processing at step S33, the power headroom corresponding to the number of RBs and the MCS specified by the radio base station 10 is calculated by the power headroom calculation unit 93, and the power headroom information calculated is transmitted to the radio base station 10.

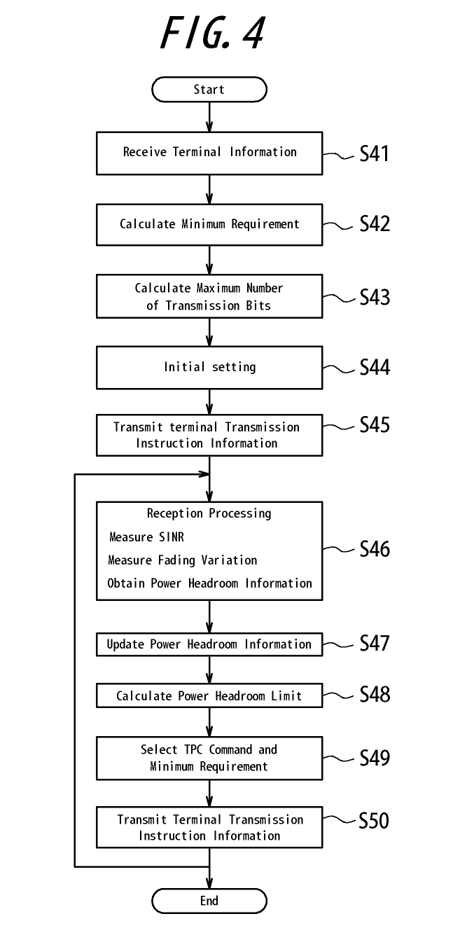

Next, operations of the radio base station 10 according to the present embodiment shown in FIG. 1 is described with reference to FIG. 4 to FIG. 6.

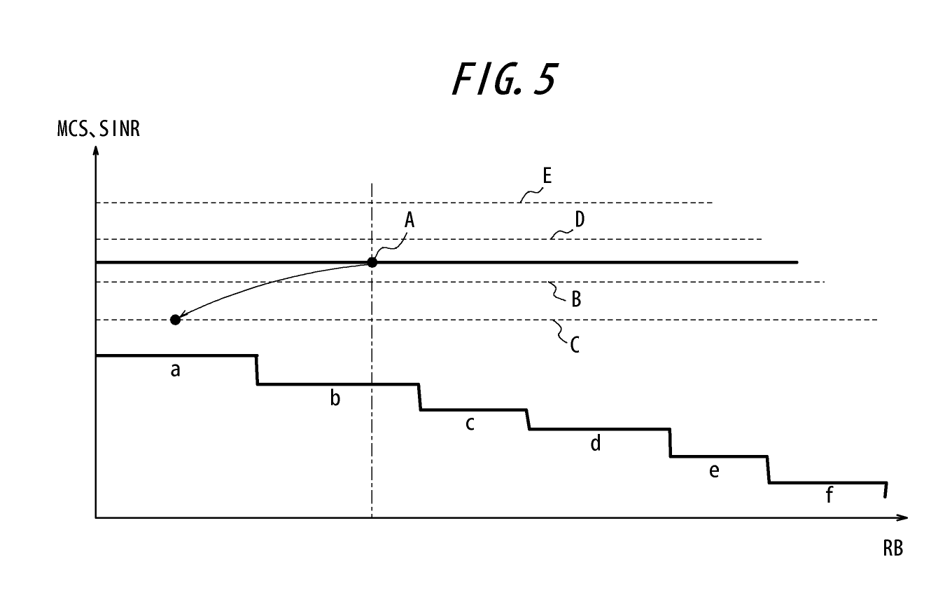

FIG. 4 is a flowchart illustrating schematic operations by the radio base station 10. First, the terminal information obtaining unit 34 of the radio base station 10 obtains the terminal information from the radio terminal 60 (step S41). Then, based on the terminal information (maximum buffer size) obtained, the required MCS calculation unit 41 calculates the minimum requirement indicating the relation between the number of RBs and MCS for CNR required for ensuring a minimum level of QoS for the communication with the radio terminal 60 (step S42). A result of calculation is stored in the terminal allocation information memory unit 45. Thereby, the terminal allocation information memory unit 45 stores a table of relation among the number of RBs, MCS and CNR required for ensuring a minimum level of QoS for the radio terminal 60. Here, the relation between the number of RBs and MCS (minimum requirement) required for ensuring a minimum level of QoS is that, as shown by a-f in FIG. 5, for example, as the number of RBs increases, MCS becomes lower, that is, a modulation type with a lower modulation level is set.

In addition, the maximum transmission bit number calculation unit 42 of the radio base station 10 calculates the maximum number of transmission bits corresponding to the number of allocated RBs based on the terminal information (maximum buffer size) obtained by the terminal information obtaining unit 34 (step S43) and stores a result of calculation in the terminal allocation information memory unit 45. Here, the maximum number of transmission bits corresponding to the number of allocated RBs is reduced according to an increase of the number of RBs.

Then, the radio base station 10 initially sets the transmit power, the number of RBs and MCS to meet QoS of the radio terminal 60 based on the terminal information and the like of other radio terminals which perform communications simultaneously, already stored in the terminal allocation information memory unit 45 (step S44). The radio base station 10 transmits initial setting information as the terminal transmission instruction information to the radio terminal 60 in order to start the necessary communication (step S45).

Upon start of the communication, the reception control unit 30 of the radio base station 10 performs reception processing (step S46), in which the reception quality calculation unit 31 calculates SINR of the received signal, the propagation environment measurement unit 32 measures the fading variation and the difference information obtaining unit 33 obtains the power headroom information.

Then, when the difference information obtaining unit 33 obtains the power headroom information, the power headroom limit calculation unit 43 of the radio base station 10 updates the power headroom information (step S47). Subsequently, the number of allocated RBs and MCS, that is, the minimum requirement which can be set for the radio terminal 60 is calculated based on the power headroom information updated (step S48).

Next, the TPC command selection unit 46 and the MCS resource allocation selection unit 47 of the radio base station 10 select the TPC command specifying the transmit power for the next transmission of the radio terminal 60 and the minimum requirement (the number of RBs and MCS), respectively (step S49). The terminal transmission instruction information selected is transmitted to the radio terminal 60 (step S50). Thereafter, processing from step S46 to step S50 is repeated to execute communication.

Here, it is assumed that the number of RBs and MCS for the uplink of the radio terminal 60 currently satisfy a minimum requirement b as shown in FIG. 5. In addition, it is assumed in this state that a value A represents SINR with current transmission output of the radio terminal 60 calculated by the reception quality calculation unit 31 of the radio base station 10, whereas values B-E represent SINR with the transmit power selectable by the TPC command, predicted by the reception SINR prediction calculation unit 44 based on the value A. The value B is predicted SINR at transmit power obtained by reducing 1 dB from the current transmit power of the radio terminal 60, for example. In a similar manner, the value C is predicted SINR at transmit power obtained by reducing 3 dB from the current transmit power, the value D is predicted SINR at transmit power obtained by increasing 1 dB to the current transmit power and the value E is predicted SINR at transmit power obtained by increasing 3 dB.

In this case, it is possible to select the TPC command to reduce the current transmit power by 3 dB, while maintaining the number of RBs and MCS of the minimum requirement b. However, controlling in this manner makes a sufficient difference between the minimum requirement b of the number of RBs and the MCS required for QoS and the predicted SINR, causing too much QoS and thus unable to adequately reduce power consumption of the radio terminal 60. Therefore, the radio base station 10 according to the present embodiment selects, in this case, a minimum requirement a for the number of RBs and MCS while selecting the TPC command to reduce the current transmit power of the radio terminal 60 by 3 dB such as to maximally meet the minimum requirement a, that is, to approach to the minimum requirement a.

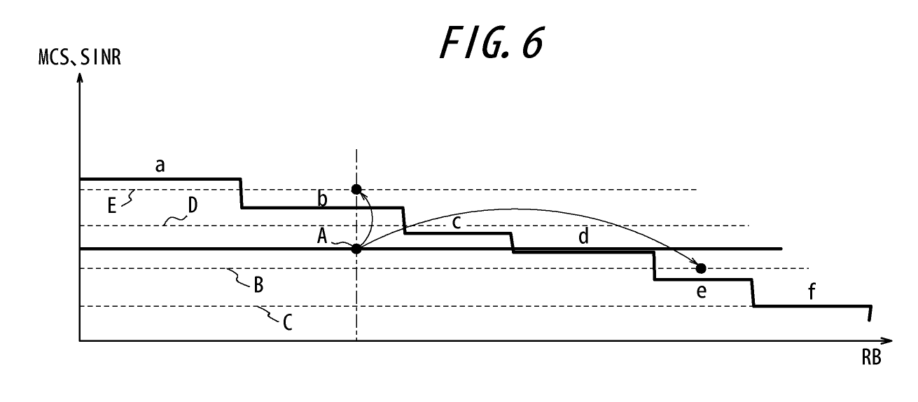

In addition, it is controlled as follows if SINR (value A) with the current transmission output of the radio terminal 60 does not meet the minimum requirement b of QoS, as shown in FIG. 6. That is, as shown in FIG. 6, because the value E meets the minimum requirement b, as a first control method, the TPC command to increase the transmit power by 3 dB is selected while maintaining the number of RBs and MCS of the minimum requirement b. Alternatively, as a second control method, under a condition that it is allowed by the power headroom limit calculation unit 43, a TPC command to select a minimum requirement e for the number of RBs and MCS while reducing the transmit power by 1 dB is selected. Selection between the first control method and the second control method is determined based on a priority set in advance, for example, according to whether to change the number of RBs.

Although the number of RBs and MCS of the minimum requirements a-f are different as shown in FIG. 5 and FIG. 6, it may be possible that only MCS varies while the number of RBs remains the same or vice versa as the minimum requirement. In these cases, it is controlled to change only MCS while maintaining the same number of RBs or to change only the number of RBs while maintaining the same MCS according to the minimum requirement selected such that the minimum requirement is maximally met.

As stated above, the radio base station 10 according to the present embodiment calculates SINR based on the signal received from the radio terminal 60 and measures the fading variation. Then, based on these information and the power headroom information from the radio terminal 60, the radio base station 10 controls at least one of the number of RBs, MCS and the TPC command for the radio terminal 60 to maximally meet the minimum requirement indicating the relation between the number of RBs and MCS for the uplink required to ensure a minimum level of the required quality for the communication with the radio terminal 60. Thereby, it is possible to adaptively and efficiently control by relating the number of RBs, MCS and the transmit power of the radio terminal 60 to one another, which enables to reliably ensure a required communication quality without excessive power consumption by the radio terminal 60.

It is to be understood that the present invention is not limited to the above embodiment but may be modified or varied in a multiple of manners. For example, the present invention is widely applicable not only to the radio base station in conformity with LTE but also radio base stations adopting radio communication systems, such as WiMAX (Worldwide Interoperability for Microwave Access), UMB (Ultra Mobile Broadband), next generation PHS (Personal Handy-phone System), IMT-Advanced (International Mobile Telecommunication Advanced) and the like, for performing a radio communication by allocating a different radio resource to each of a plurality of radio terminals In the above embodiment, in addition, the MCS resource allocation selection unit 47 may select the minimum requirement to control next without consideration of the fading variation measured by the propagation environment measurement unit 32.

### REFERENCE SIGNS LIST

10 radio base station
20 RF reception unit
30 reception control unit
31 reception quality calculation unit
32 propagation environment measurement unit
33 difference information obtaining unit
34 terminal information obtaining unit
40 transmission control unit
41 required MCS calculation unit
42 maximum transmission bit number calculation unit
43 power headroom limit calculation unit
44 reception SINR prediction calculation unit
45 terminal allocation information memory unit
46 TPC command selection unit
47 MCS resource allocation selection unit
48 terminal transmission instruction unit
50 RF transmission unit

1. A radio base station comprising:
a reception quality calculation unit for calculating a reception quality based on a signal received from a radio terminal;
a difference information obtaining unit for obtaining difference information between maximum transmit power and current transmit power, transmitted from the radio terminal;
a minimum requirement calculation unit for calculating a minimum requirement indicating a relation between a number of resource blocks and a modulation type, necessary to ensure a minimum level of quality required for communication with the radio terminal, wherein the resource block is a unit block with a predetermined frequency bandwidth; and
a control unit for controlling at least one of the number of resource blocks, the modulation type and transmit power for uplink of the radio terminal, such that the minimum requirement calculated by the minimum requirement calculation unit is maximally met, based on the reception quality calculated by the reception quality calculation unit and the difference information obtained by the difference information obtaining unit.

2. The radio base station according to claim 1, further comprising a propagation environment measurement unit for measuring a fading variation based on a signal received from the radio terminal, wherein
the control unit selects a corresponding minimum requirement among minimum requirements calculated by the minimum requirement calculation unit based on the fading variation measured by the propagation environment measurement unit, and controls the number of resource blocks and the modulation type of the radio terminal to the minimum requirement selected and controls the transmit power of the radio terminal such that the minimum requirement selected is maximally met.

3. A communication control method comprising the steps of:
calculating a reception quality based on a signal received from a radio terminal;
obtaining difference information between maximum transmit power and current transmit power, transmitted from the radio terminal;
calculating a minimum requirement indicating a relation between a number of resource blocks and the modulation type, necessary to ensure a minimum level of quality required for communication with the radio terminal, wherein the resource block is a unit block with a predetermined frequency bandwidth; and
controlling at least one of the number of resource blocks, the modulation type and transmit power for uplink of the radio terminal such that the minimum requirement calculated at the step of calculating the minimum requirement is maximally met, based on the reception quality calculated at the step of calculating the reception quality and the difference information obtained at the step of obtaining the difference information.
